(19) United States
(12) Patent Application Publication
(10) Pub. No.: US 2020/0056622 A1
(43) Pub. Date: Feb. 20, 2020

(54) SEALING ASSEMBLY FOR CENTRIFUGAL COMPRESSOR AND CENTRIFUGAL COMPRESSOR HAVING THE SAME

(71) Applicant: Carrier Corporation, Jupiter, FL (US)

(72) Inventors: Ye Tian, Shanghai (CN); Vishnu M. Sishtla, Manlius, NY (US)

(21) Appl. No.: 16/604,061

(22) PCT Filed: Apr. 11, 2018
(86) PCT No.: PCT/US2018/027056

§ 371 Date: Oct. 9, 2019

(30) Foreign Application Priority Data
Apr. 14, 2017 (CN) 201710243405.1

(51) Int. Cl. F04D 29/08; F04D 29/28

(52) U.S. Cl. CPC F04D 29/083; F16J 15/445; F04D 29/284

(57) ABSTRACT

The present invention provides a seal assembly for use in a centrifugal compressor and a centrifugal compressor having same. The centrifugal compressor comprises an impeller and a housing, wherein the impeller comprises a gimbal, provided on the back of the impeller, having an inner diameter and an outer diameter; and the seal assembly for use in a centrifugal compressor comprises a sealing section, the sealing section comprising a sealing tooth formed on the impeller and a sealing ring provided on the housing, wherein an elastic part is provided on a contact surface of the sealing ring with the sealing tooth. According to the seal assembly of the present invention, the sealing clearance between the sealing ring and the sealing tooth is effectively reduced by way of multiple sets of sealing sections and the elastic parts provided therebetween.

### TECHNICAL FIELD

The present invention relates to the field of compressors, and more specifically, to a seal assembly for use in a centrifugal compressor.

### BACKGROUND ART

At present, in order to ensure the sealing performance between various parts in a centrifugal compressor, a seal assembly is usually provided between the parts so as to form a sealing surface therebetween. For example, as an example, in a design scheme, a seal assembly is provided on the side of a gimbal of a centrifuge impeller. At this moment, it is possible to provide a sealing ring on the gimbal end face and provide a sealing tooth on a contact surface of the sealing ring with the gimbal, thus forming a sealing surface between the sealing tooth and the gimbal.

Such sealing surface is limited by the size of the sealing section and the size of the sealing clearance between the sealing tooth and the gimbal and can only bring the sealing effect of average reliability. Whereas if a seal failure occurs, the high-pressure refrigerant at the outlet of the impeller will be leaked through the sealing clearance to the impeller back side where the pressure is relatively low, which will reduce the efficiency of the centrifugal compressor, and even cause potential safety hazard.

It can be known, according to the design principle of sealing, that the sealing performance can be improved both by increasing the sealing section and by reducing the sealing clearance. However, in fact, it is difficult to further improve the sealing performance of a current structure based on the previously stated principle. On the one hand, confined to the assembly space, it is difficult to increase the sealing surface between the gimbal and the sealing ring by increasing the length of the gimbal along the axial direction. On the other hand, because the sealing tooth and the gimbal have similar material hardness, if the two are fully contacted or too close, severe abrasion or safety problems will be caused. Therefore, for safety reasons, the static clearance between the sealing tooth on the sealing ring and the gimbal can no longer be reduced.

### SUMMARY OF INVENTION

An objective of the present invention is to provide a seal assembly having a smaller sealing clearance for use in a centrifugal compressor.

Another objective of the present invention is to provide a centrifugal compressor having improved sealing performance.

In order to achieve the objective of the present invention, according to one aspect of the present invention, a seal assembly for use in a centrifugal compressor is provided, the centrifugal compressor including an impeller and a housing, wherein the impeller includes a gimbal, provided on the back of the impeller, having an inner diameter and an outer diameter, characterized in that the seal assembly includes a sealing section, the sealing section including a sealing tooth formed on the impeller and a sealing ring provided on the housing, wherein an elastic part is provided on a contact surface of the sealing ring with the sealing tooth.

In order to achieve another objective of the present invention, according to another aspect of the present invention, a centrifugal compressor is also provided, which includes the seal assembly for use in a centrifugal compressor as previously stated.

### BRIEF DESCRIPTION OF THE DRAWINGS

FIG. 1 is a schematic diagram of an embodiment of a seal between the impeller and the housing of the present invention.

FIG. 2 is a schematic diagram of another embodiment of the seal between the impeller and the housing of the present invention.

FIG. 3 is a schematic diagram of another embodiment of the seal between the impeller and the housing of the present invention.

FIG. 4 is a schematic diagram of another embodiment of the seal between the impeller and the housing of the present invention.

FIG. 5 is a schematic diagram of another embodiment of the seal between the impeller and the housing of the present invention.

FIG. 6 is a schematic diagram of another embodiment of the seal between the impeller and the housing of the present invention.

FIG. 7 is a schematic diagram of another embodiment of the seal between the impeller and the housing of the present invention.

FIG. 8 is a schematic diagram of another embodiment of the seal between the impeller and the housing of the present invention.

FIG. 9 is a schematic diagram of another embodiment of the seal between the impeller and the housing of the present invention.

FIG. 10 is a schematic diagram of another embodiment of the seal between the impeller and the housing of the present invention.

FIG. 11 is a schematic diagram of another embodiment of the seal between the impeller and the housing of the present invention.

FIG. 12 is a schematic local diagram of an embodiment of the centrifugal compressor of the present invention.

### DETAILED DESCRIPTION

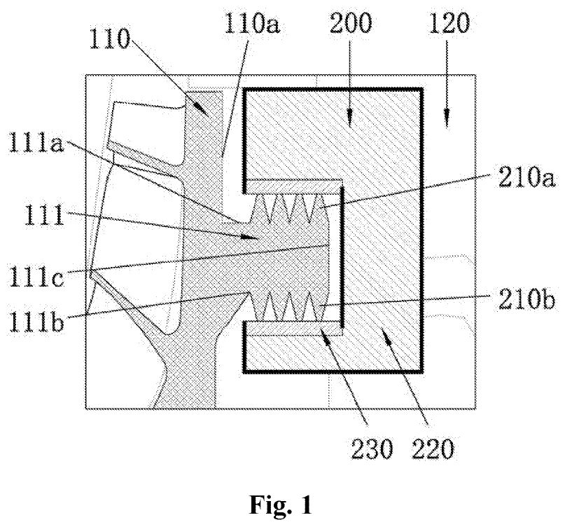

Referring to FIG. 1 to FIG. 12, several embodiments of the seal assembly for use in a centrifugal compressor 100 of the present invention are shown. The centrifugal compressor 100 applying this seal assembly includes an impeller 110 and a housing 120. Specifically, the impeller 110 includes a gimbal 111 provided on the back 110a of the impeller, and the housing 120 is provided near the back 110a of the impeller 110.

The seal assembly in this embodiment includes a plurality of sets of sealing sections 200 which are used to provide a seal between the impeller 110 and the housing 120; the sealing sections 200 include sealing teeth 210a, 210b, 210c, and 210d integrally formed on the impeller 110 and a sealing ring 220 provided on the housing 120, wherein an elastic cushion 230 is provided on a contact surface of the sealing ring 220 with the sealing teeth 210a, 210b, 210c, and 210d. In such arrangement, because the plurality of sets of sealing sections 200 are designed, the sealing area between the impeller 110 and the housing 120 is effectively increased, thus improving the sealing performance thereof. In addition, the sealing teeth 210a, 210b, 210c, and 210d can keep an extremely small space or even be directly in contact with the elastic cushion 230 on the sealing ring 220, which will greatly reduce the sealing clearance and even realize a static sealing clearance of 0, thus effectively enhancing the sealing performance thereof as well.

Specifically, the below provides a conception about how to particularly arrange the plurality of sets of sealing sections.

In summary, it is possible to utilize the plurality of sets of sealing sections 200 to provide a plurality of sets of axial seals or a plurality of sets of radial seals, or provide at least one set of axial seal and at least one set of radial seal at the same time between the impeller 110 and the housing 120. For example, in the case that the arrangement space and the arrangement cost are considered, 2-4 sealing sections 200 can be provided to provide 2-4 seals between the impeller 110 and the housing 120. More specifically, the 2-4 sets of sealing sections 200 can be used to provide 1-2 axial seals and/or 1-2 radial seals between the impeller 110 and the housing 120.

Specifically, as shown in FIG. 1, the axial seal between the impeller 110 and the housing 120 includes: sealing the sealing tooth 210a on the outer diameter end face 111a of the gimbal 111 and the sealing ring 220 on the housing 120; or sealing the sealing tooth 210b on the inner diameter end face 111b of the gimbal 111 and the sealing ring 220 on the housing 120; or sealing both of the above two at the same time.

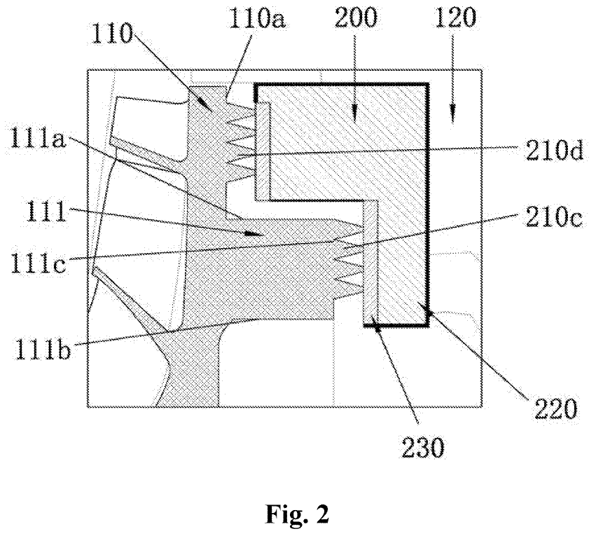

In addition, as shown in FIG. 2, the radial seal between the impeller 110 and the housing 120 includes: sealing the sealing tooth 210c on the axial end face 111c of the gimbal 111 and the sealing ring 220 on the housing 120; or sealing the sealing tooth 210d on the outside back 110a of the impeller 110 and the sealing ring 220 on the housing 120; or sealing both of the above two at the same time. As shown in FIG. 2, the outside back 110a of the impeller 110 here is located outside of the gimbal 111.

Here, specific improvements to various elements within several seal assemblies and the cooperative relationship thereof with the kit of the centrifugal compressor are also provided.

For example, the sealing tooth 210d is integrally formed on the back 110a of the impeller 110; while the sealing teeth 210a, 210b, and 210c are integrally formed on the gimbal 111. More specifically, the sealing tooth 210a is integrally formed on the outer diameter end face 111a of the gimbal 111; the sealing tooth 210b is integrally formed on the inner diameter end face 111b of the gimbal 111; and the sealing tooth 210c is integrally formed on the axial end face 111c of the gimbal 111.

As another example, the hardness of the elastic cushion 230 should be lower than the hardness of the sealing teeth 210a, 210b, 210c, and 210d, which, on the one hand, ensures that the sealing teeth can be in contact or keep an extremely small clearance with the elastic cushion, and on the other hand, also ensures that the elastic cushion has a relatively long service life. As a specific example, the elastic cushion 230 is made from soft base alloy (e.g. Babbitt metal) or high polymer material (e.g. polyether-ether-ketone, polytetrafluoroethylene) or other materials with a small friction coefficient, good creep resistance, and the hardness smaller than the impeller 110.

For another example, to reduce the number of parts, the sealing ring 220 can be integrated with the housing 120; and the elastic cushion 230 can also be integrated with the sealing ring 220. Whereas for the convenience of parts processing, the elastic cushion 230 can be made into a separate part and connected to the sealing ring 220.

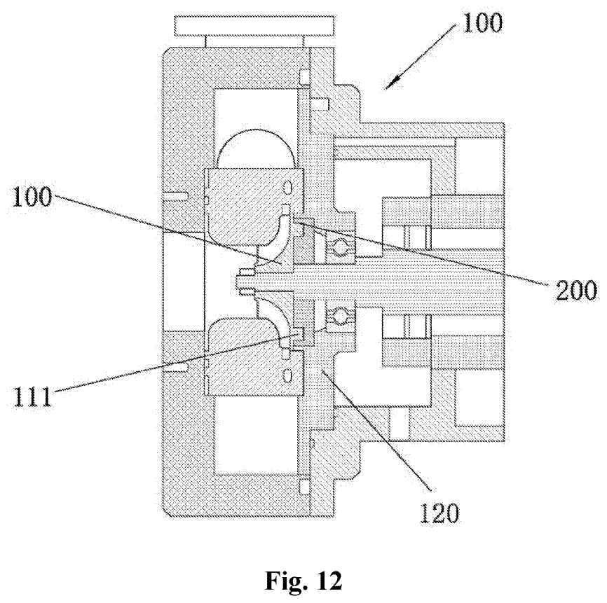

As another embodiment, referring to FIG. 12, a centrifugal compressor 100 is also provided here, which includes the seal assembly described in any of the previous embodiments. It can be known from the drawings that the seal assembly is mainly arranged between the outer edge of the impeller 110 and the housing 120; or arranged between the gimbal 111 and the housing 120; or both.

To further explain the arrangement position and arrangement manner of the sealing section within the compressor, several embodiments are provided below in conjunction with the accompanying drawings for explanation.

FIG. 1 to FIG. 6 show an embodiment having two sets of sealing sections.

Referring to FIG. 1, the sealing teeth 210a and 210b are respectively provided on the outer diameter end face 111a and the inner diameter end face 111b of the gimbal 111; and the corresponding sealing ring 220 is provided in a “]” shape so as to surround the outer diameter end face 111a and the inner diameter end face 111b of the gimbal 111. Two sealing pads 230 are respectively provided on an adjoining surface of the sealing ring 220 with the two sealing teeth 210a and 210b, thereby forming two axial seals.

Referring to FIG. 2, the sealing teeth 210c and 210d are respectively provided on the axial end face 111c of the gimbal 111 and the outside back 110a of the impeller 110; and the corresponding sealing ring 220 is provided in a “L” shape so as to surround the axial end face 111c of the gimbal 111 and the outside back 110a of the impeller 110. Two sealing pads 230 are respectively provided on the adjoining surface of the sealing ring 220 with the two sealing teeth 210c and 210d, thereby forming two radial seals.

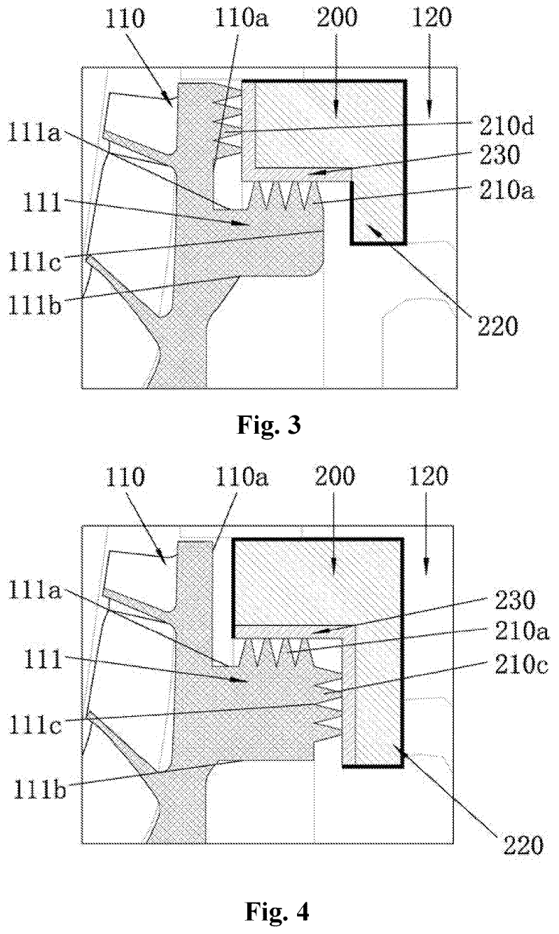

Referring to FIG. 3, the sealing teeth 210a and 210d are respectively provided on the outer diameter end face 111a of the gimbal 111 and the outside back 110a of the impeller 110; and the corresponding sealing ring 220 is provided in a “L” shape so as to surround the outer diameter end face 111a of the gimbal 111 and the outside back 110a of the impeller 110. Two sealing pads 230 are respectively provided on the adjoining surface of the sealing ring 220 with the two sealing teeth 210a and 210d, thereby forming one axial seal and one radial seal.

Referring to FIG. 4, the sealing teeth 210a and 210c are respectively provided on the outer diameter end face 111a and the axial end face 111c of the gimbal 111; and the corresponding sealing ring 220 is provided in a “L” shape so as to surround the outer diameter end face 111a and the axial end face 111c of the gimbal 111. Two sealing pads 230 are respectively provided on the adjoining surface of the sealing ring 220 with the two sealing teeth 210a and 210c, thereby forming one axial seal and one radial seal.

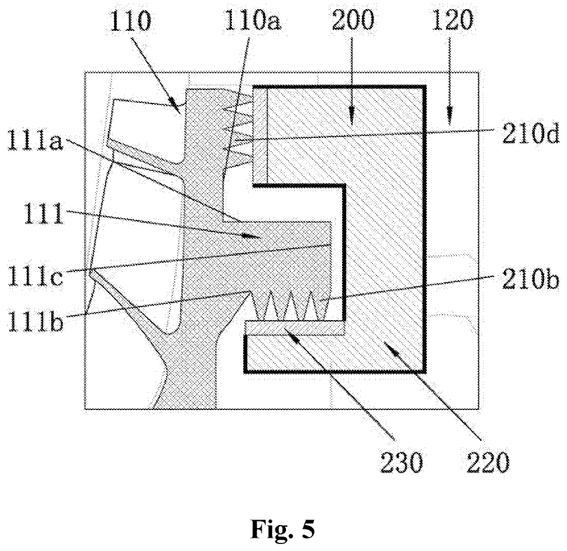

Referring to FIG. 5, the sealing teeth 210b and 210d are respectively provided on the inner diameter end face 111b of the gimbal 111 and the outside back 110a of the impeller 110; and the corresponding sealing ring 220 is provided in a “]” shape so as to surround the inner diameter end face 111b of the gimbal 111 and the outside back 110a of the impeller 110. Two sealing pads 230 are respectively provided on the adjoining surface of the sealing ring 220 with the two sealing teeth 210b and 210d, thereby forming one axial seal and one radial seal.

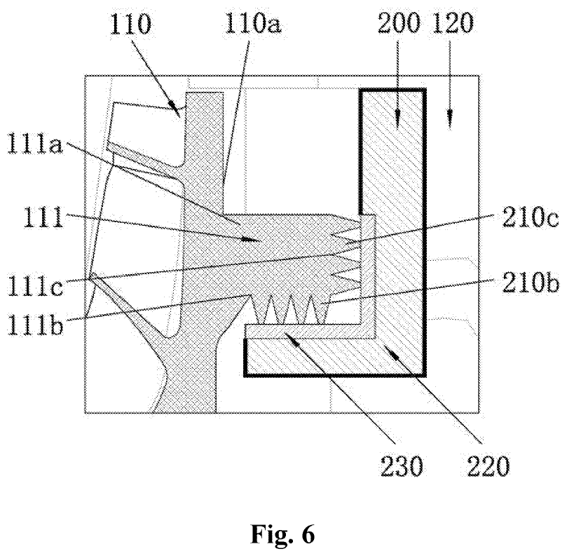

Referring to FIG. 6, the sealing teeth 210b and 210c are respectively provided on the inner diameter end face 111b and the axial end face 111c of the gimbal 111; and the corresponding sealing ring 220 is provided in a “L” shape so as to surround the inner diameter end face 111b and the axial end face 111c of the gimbal 111. Two sealing pads 230 are respectively provided on the adjoining surface of the sealing ring 220 with the two sealing teeth 210b and 210c, thereby forming one axial seal and one radial seal.

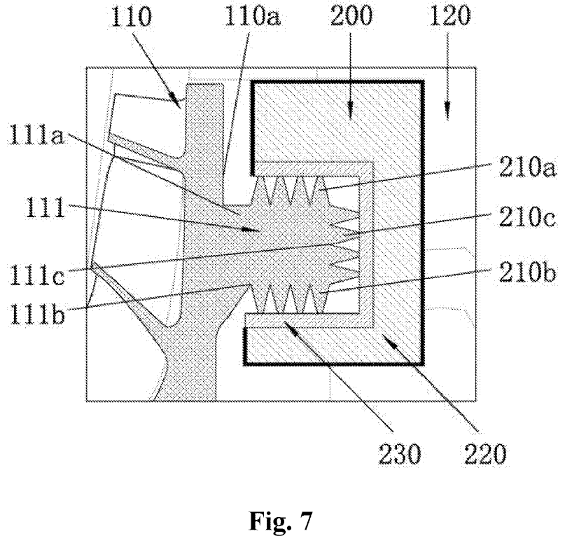

FIG. 7 to FIG. 10 show an embodiment having three sets of sealing sections.

Referring to FIG. 7, the sealing teeth 210a, 210b and 210c are respectively provided on the outer diameter end face 111a, the inner diameter end face 111b and the axial end face 111c of the gimbal 111; and the corresponding sealing ring 220 is provided in a “]” shape so as to surround the outer diameter end face 111a, the inner diameter end face 111b and the axial end face 111c of the gimbal 111. Three sealing pads 230 are respectively provided on the adjoining surface of the sealing ring 220 with the three sealing teeth 210a, 210b and 210c, thereby forming two axial seals and one radial seal.

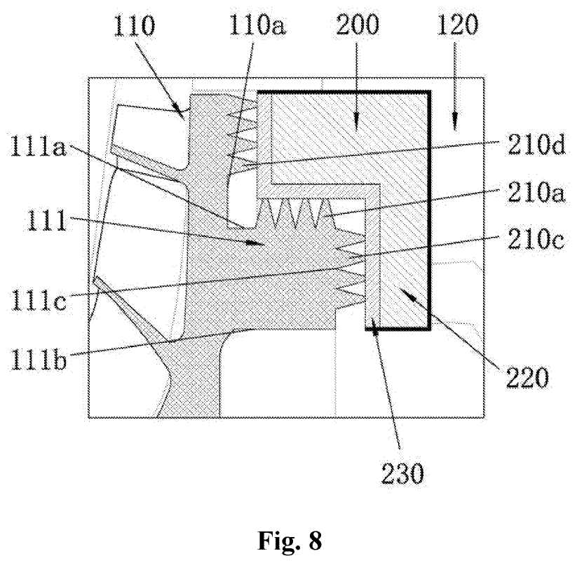

Referring to FIG. 8, the sealing teeth 210a and 210c are respectively provided on the outer diameter end face 111a and the axial end face 111c of the gimbal 111, and the sealing tooth 210d is provided on the outside back 110a of the impeller 110; and the corresponding sealing ring 220 is provided in a “L” shape so as to surround the outer diameter end face 111a and the axial end face 111c of the gimbal 111 and the outside back 110a of the impeller 110. Three sealing pads 230 are respectively provided on the adjoining surface of the sealing ring 220 with the three sealing teeth 210a, 210c and 210d, thereby forming one axial seal and two radial seals.

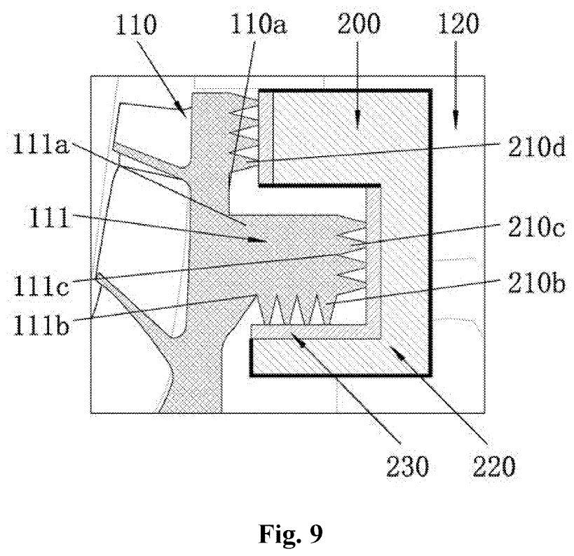

Referring to FIG. 9, the sealing teeth 210b and 210c are respectively provided on the inner diameter end face 111b and the axial end face 111c of the gimbal 111, and the sealing tooth 210d is provided on the outside back 110a of the impeller 110; and the corresponding sealing ring 220 is provided in a “]” shape so as to surround the inner diameter end face 111b and the axial end face 111c of the gimbal 111 and the outside back 110a of the impeller 110. Three sealing pads 230 are respectively provided on the adjoining surface of the sealing ring 220 with the three sealing teeth 210b, 210c and 210d, thereby forming one axial seal and two radial seals.

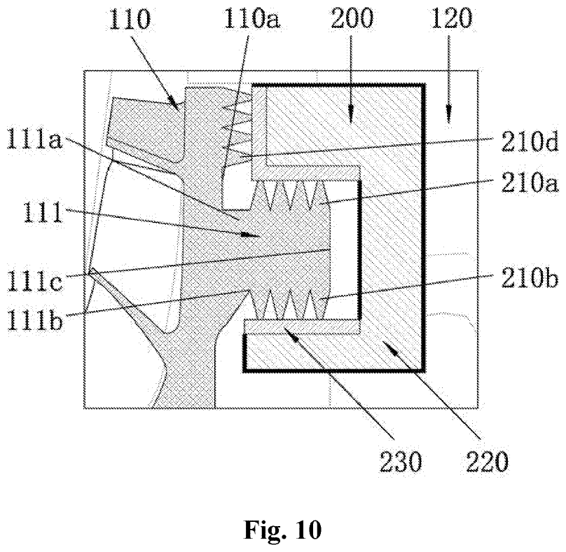

Referring to FIG. 10, the sealing teeth 210a and 210b are respectively provided on the outer diameter end face 111a and the inner diameter end face 111b of the gimbal 111, and the sealing tooth 210d is provided on the outside back 110a of the impeller 110; and the corresponding sealing ring 220 is provided in a “]” shape so as to surround the outer diameter end face 111a and the inner diameter end face 111b of the gimbal 111 and the outside back 110a of the impeller 110. Three sealing pads 230 are respectively provided on the adjoining surface of the sealing ring 220 with the three sealing teeth 210a, 210b and 210d, thereby forming two axial seals and one radial seal.

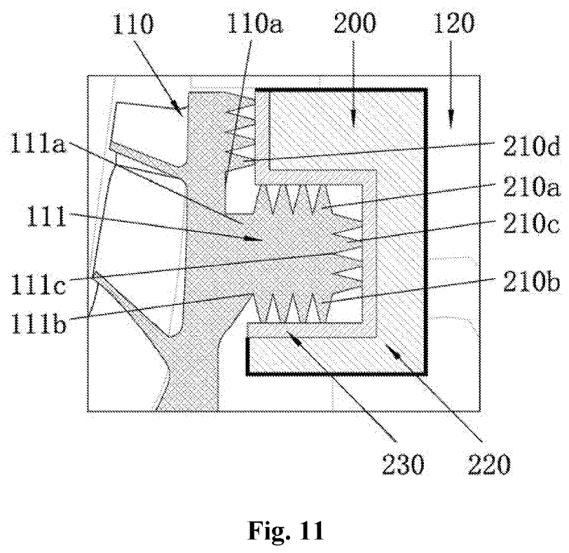

FIG. 11 shows an embodiment having four sets of sealing sections.

Referring to FIG. 11, the sealing teeth 210a, 210b and 210c are respectively provided on the outer diameter end face 111a, the inner diameter end face 111b and the axial end face 111c of the gimbal 111, and the sealing tooth 210d is provided on the outside back 110a of the impeller 110; and the corresponding sealing ring 220 is provided in a “1” shape so as to surround the outer diameter end face 111a, the inner diameter end face 111b and the axial end face 111c of the gimbal 111 and the outside back 110a of the impeller 110. Four sealing pads 230 are respectively provided on the adjoining surface of the sealing ring 220 with the four sealing teeth 210a, 210b, 210c and 210d, thereby forming two axial seals and two radial seals.

The above examples mainly explain the seal assembly for use in a centrifugal compressor and the centrifugal compressor system having same of the present invention. Although only some of the implementation manners of the present invention are described, a person of ordinary skill in the art should understand that the present invention can be implemented in many other forms without deviating from the purpose and scope thereof. Therefore, the illustrated examples and implementation manners are deemed as schematic rather than restrictive, and the present invention may cover various modifications and substitutions without deviating from the spirit and scope of the present invention as defined by each of the attached claims.

What is claimed is:

1. A seal assembly for use in a centrifugal compressor, the centrifugal compressor comprising an impeller and a housing, wherein the impeller comprises a gimbal, provided on the back of the impeller, having an inner diameter and an outer diameter, characterized in that the seal assembly comprises:
a sealing section, the sealing section comprising a sealing tooth formed on the impeller and a sealing ring provided on the housing, wherein an elastic part is provided on a contact surface of the sealing ring with the sealing tooth.

2. The seal assembly according to claim 1, characterized in that the sealing section provides an axial seal and/or a radial seal between the impeller and the housing.

3. The seal assembly according to claim 2, characterized in that the axial seal between the impeller and the housing comprises:
a seal between a sealing tooth on an outer diameter end face of the gimbal and the sealing ring; and/or
a seal between a sealing tooth on an inner diameter end face of the gimbal and the sealing ring.

4. The seal assembly according to claim 2, characterized in that the radial seal between the impeller and the housing comprises:
a seal between a sealing tooth on an axial end face of the gimbal and the sealing ring; and/or
a seal between a sealing tooth on an outside back of the impeller and the sealing ring.

5. The seal assembly according to claim 2, characterized in that the sealing section comprises 1-2 axial sealing sections and/or 1-2 radial sealing sections between the impeller and the housing.

6. The seal assembly according to claim 1, characterized in that the sealing section comprises 2-4 sealing sections which are used to provide 2-4 sealing sections between the impeller and the housing.

7. The seal assembly according to claim 1, characterized in that the sealing tooth is integrally formed on the back of the impeller and/or the gimbal.

8. The seal assembly according to claim 7, characterized in that the sealing tooth is integrally formed on the inner diameter end face and/or the outer diameter end face and/or the axial end face of the gimbal.

9. The seal assembly according to claim 1, characterized in that the hardness of the elastic part is lower than the hardness of the sealing tooth.

10. The seal assembly according to claim 1, characterized in that the elastic part is integrated with the sealing ring; or the elastic part is fixedly connected to the sealing ring.

11. The seal assembly according to claim 1, characterized in that the elastic part is made from soft base alloy or high polymer material.

12. The seal assembly according to claim 1, characterized in that the sealing ring is integrated with the housing.

13. A centrifugal compressor, characterized by comprising the seal assembly for use in a centrifugal compressor according to claim 1.
